(19) United States
(12) Patent Application Publication
(10) Pub. No.: US 2005/0167860 A1
(43) Pub. Date: Aug. 4, 2005

(54) Method for ambient air and forced air scenting based on replaceable, liquid scent cartridges and a mountable or removable/portable holding case for said cartridges

(76) Inventor: Daren Karl Brooks, St. George, UT (US)

Correspondence Address: Daren K. Brooks, 356 N Main, St George, UT, 84770, US

(21) Appl. No.: 10/766,269

(22) Filed: Jan. 29, 2004

(51) Int. Cl. B01F 3/04

(52) U.S. Cl. 261/81; 261/DIG. 88

(57) ABSTRACT

A new method for freshening air by providing an unlimited variety of, and instantly changeable scents including all standard and all possible combinations of scents, disinfectant scents and like solutions, and aroma therapy scents. Comprising: a base unit having slots for holding at least one cartridge per slot and various attaching methods on said base unit for attachment to air vents of all types and non-conductive, permanent or foldable, plastic prongs on said base unit to insert into electrical outlets for alternate mounting, and an adhesive patch on said base unit providing extra support in said vents, electrical outlets, or mounting configurations of all types. Further, a non-electric, manual, scent delivery method. Comprising: replaceable, self-contained, non-pressurized, scent cartridges with removable, atomizing, pump tops to be contained within the base unit. This proposed scent delivery system has no mechanically moving parts, no electrical requirement of any kind, is inexpensive to manufacture and sell, and no scent waste of any kind. Also, since this proposed scent delivery system is completely installable, removable, storable, and serviceable by any operator; thus solving many deficiencies that until now, have not been addressed in one, inexpensive unit.

### BACKGROUND OF THE INVENTION

1. Field of the Invention

The present invention relates to a method for refreshing and/or disinfecting ambient or forced air streams. Still more particularly, the present invention relates to a base unit that contains removable cartridges for scenting or disinfecting air streams or ambient air wherein a fragrance, a disinfectant, or other functional liquid is atomized with the amount of scent dispersal controlled manually by preferences of the user.

Moreover, in the present context, the term “freshening” means either scenting, disinfecting, or scenting and disinfecting, such as for an air stream or ambient air.

2. Description of Related Art

Scenting of ambient air, air streams, and scenting of air in all spaces has been the subject of much discussion, prior invention, and prior art. All animals and organisms “breathe” in various ways, thus the quality of air can be critical. There are environmental, biological, and industrial illnesses of all types that are airborne and can be treated with atomized solutions. Further, even when air is adequately healthy to breathe, there can still be smells and scents that are very unpleasant and uncomfortable. Aroma therapists have demonstrated that these smells, or lack thereof, can have an impact on many aspects of human performance even though biological problems from infected air may not be present. The smell, freshness, and specific aromas of air can effect human mood, emotions, sleep, work performance, relaxation and sensuality. This invention addresses these and other issues with an effective, inexpensive, and simple to operate scent delivery system to freshen any air environment.

To address the problems of smell inherent to re-circulating air, the air-conditioning system has been investigated in the past as a means of introducing scents into the air stream thus treating both the forced and ambient air. A system fitting this description is disclosed in U.S. Pat. No. 3,044,276 to Kauten. Further, in U.S. Pat. No. 4,604,114, Ward discloses a scented air filter. Fragrant rods within the padding emit scent as air passes over them but if the fragrance is depleted, the entire filter itself must be replaced at a substantial expense. This expense for freshening must be incurred even if the filter itself is still functional. U.S. Pat. No. 6,117,218 to Snyder et al. discloses a scenting device for attachment to an air filter in a heating, ventilating, or air conditioning (HVAC) system. However, Snyder's device provides gel-containing compartments mounted on a solid surface that is in turn attached to an air filter making changes cumbersome and complicated each time a stronger or new scent is desired. This method also forces the user to endure the latest scent installed until it evaporates completely.

Recently, there have been patents and developments relate to dispersing scents into the air by the use of ionization. (see WO 00/38512).

The combination of antimicrobial solutions and scent dispersal has also been previously disclosed as, for example, in U.S. Pat. No. 6,110,888 to Lupo et al. Also, in U.S. Pat. No. 5,415,675 to Powers et al., is described a fragrant sponge strip which mounts onto an air filter. This fragrant sponge strip has multiple hooks located on the outer edge of the sponge thus requiring the filter to have apertures adapted to receive said hooks. Accordingly, the Powers Sponge Strip is not adapted to be used with all filter systems and could only be effective when there are apertures present for receiving the hooks of the sponge. Again, the user of this method must endure the lifespan of the scent before changing scents unless the entire unit is replaced.

The term “air quality” can be more broadly interpreted as functional, pleasant smelling and safe. “Air quality” also relates to simple air scenting for the purpose of pleasure and elimination of bad odors. This has led to many developments relative to this concept, such as those disclosed in the following patents: U.S. Pat. No. 5,549,247 to Rossman et al.; U.S. Pat. No. 5,431,859 to Tobin et al.; U.S. Pat. No. 5,342,584 to Fritz et al.; U.S. Pat. No. 6,267,297 B1 to Contadini et al; U.S. Pat. No. 5,038,972 to Muderlak et al.; U.S. Pat. No. 3,677,441 to Nixon et al.; and U.S. Pat. No. 5,591,409 to Watkins. U.S. Pat. No. 5,178,327 to Palamand et al.; U.S. Pat. No. 5,223,182 to Steiner et al.; U.S. Pat. No. 5,186,869 to Stumpf et al.; and finally, U.S. Pat. No. 5,147,582 to Holzner et al.

Some of these inventions and systems provide a method of scent release by actuation of piezo-electric systems, pressurized aerosols, air flow over scent-containing pieces, or by the evaporation of scented liquids or gels. Recently the detrimental effects on our environment by propellant gases has been discovered and this has prompted many to invent scent dispersal systems that use safe propellants or do not require propellants at all. These harmful propellants are often referred to as “Volatile Organic Components” (VOC) or “chlorofluorocarbons” (CFC's), both of which have been used in the past. Devices that avoid the use of propellant gases include U.S. Pat. No. 6,293,474 B1 to Helf et al.; U.S. Pat. No. 5,938,117 to Ivri; U.S. Pat. No. 6,196,219 B11 to Hess et al., and more recently EP 01 121 075.4, to Hess et al. and finally, U.S. Pat. No. 5,529,005 to Gueret. These various patents disclose the use of piezo-electric actuation to effectively disperse liquids without propellants. The main problem remaining with most of the devices above, however, is that they are complicated, expensive to produce, difficult to repair and service, and require significant time to refill scents, and change scents and intensities. Another major problem with the aforementioned devices is that they are not portable to be used in other systems of all shapes and sizes and many require electronics, mechanical components, professional installation, professional service, and even air-flow to be effective.

Consequently, to make piezo-electric systems atomize effectively, at least some solvent is generally required to properly disperse the scents or liquids. Martens et al. states, in document WO 00/47335, that ‘the viscosity and surface tension of a liquid to be dispensed can be controlled by adding certain solvents, thereby providing a method of improving the dispensing action of piezo-actuated systems.’

Further techniques for ambient air scenting and disinfecting discussed in other submitted patents and documents show the possible use of electronics and circuits to be used in timing, sequencing, and dosing of scent into various living environments, air duct work or conduit. Internationally, there have even been scent sensors used in electronic control circuitry of these scenting devices to control the release of scents and their intensity. Such as: EP 00 118 715.2 (published by the European Patent Office as document EP 1 184 083 A1) and U.S. patent application Ser. No. 09/942,118 are incorporated by reference herein. Also, French document FR 98 04156 to Moy et al.; U.S. Pat. No. 5,591,409 to Watkins; European document EP 0 831 384 A1 to Muyarama et al.; U.S. Pat. Nos. 5,832,320 and 5,760,873, both to Wittek; and European document EP 00 118 715.2 and corresponding U.S. patent application Ser. No. 09/942,118, both to Hess et al. are all examples of this in various forms.

All prior devices fail to offer enough mounting flexibility and portability to be effective in a wide variety of applications. Another problem with some prior devices and systems is condensation. Some prior devices rely on protruding pieces or processes that must be close to the dispensing unit impeding air flow or causing excess sound from the air turbulence. Another major drawback is the lack of selection of scents that are both available and instantly changeable. All seem to require some programming, refilling, disassembly, filter changes, professional service, electrical disconnection, endurance of last scent installed, evaporation, or complete replacement. Yet another common drawback to the prior devices is that the control functions are not instantly flexible and changeable which leaves the user little or no possibility of quick adjustment to his or her preferences. Another drawback is the intense beginning and subsequent slow weakening of scents. This occurs as the media in which the scent has been installed in slowly evaporates making the scent intensity difficult to monitor. In fact, in U.S. Pat. Publication No.: U.S. 2003/0097936 A1 Maleeny et al. states “An expert panel considered the vanilla scent to be strong for the first three days, pleasant for an additional fourteen days and perceptible for remainder of the test period.” In other words, it starts strong and gradually grows weaker until evaporation is complete. Prior devices contain environmental drawbacks as well. These include: scent removal, solvent additives, and poor storage ability or disposal of unwanted scents as once many of them are opened, smeared on, poured in, electrically discharged, or installed, they are impossible to return to a scent free sealed container to be stored and reused again at the discretion of the operator. This promotes waste and endurance of scent for the period of time the scent is evaporating or dispersing. In other words, the prior devices do not permit immediate selection, dispersal, changeability, or closed storage of scent at the discretion of the operator either.

Another drawback is that all aforementioned systems have components that can wear out. Comprehensively, major drawbacks of all aforementioned devices include the fact that they are not installable, serviceable, removable, storable, and re-installable by virtually any user.

Another drawback of all prior devices is the inability of all aforementioned devices and apparatuses to be completely portable to even the outdoors, and to contain multiple, changeable scents that can be changed, dispensed and/or refilled at any time by the operator.

### SUMMARY OF THE INVENTION

Consequently, there still exists the need for a method of scenting and refreshing air that improves upon prior devices. It is therefore an objective of the present invention to overcome the drawbacks of these prior devices. It has been found that the improvement of all above stated objects, as well as further improvements over the prior art, may be achieved by using cartridges contained in a base unit that is attachable to a variety of surfaces. Wherein said base unit contains removable, replaceable, seal able, storable, easily serviced cartridges containing atomizable scents. These scents contained in said cartridges can be manually distributed to airflow systems and ambient environment of all types and at the instant discretion of the operator.

In particular, it is the object of the present invention to provide the immediate change of scent to address personal preferences as well as almost unlimited scent choices with several contained at all times in base unit.

It is a further object of the present invention to elimination of waste of scent that occurs in the unregulated discharge of many material-absorbed or evaporative scent systems.

It is a further object of the present invention to provide long-term scent free storage for unwanted cartridges, whether full or partially used, thus eliminating waste and providing a method to re-use said cartridges at any time. This would especially apply to seasonal or specific scents.

It is a further object of the present invention is to eliminate the technicality of operation and provide non-technical user installation and serviceability at any time in almost any environment.

Its is a further object of the present invention to reduce the price of purchase for base unit, scent cartridges, and cartridge refills to a price point that is affordable for all.

It is a further object of the present invention to provide instant removal and complete portability of base unit and cartridges.

It is a further object of the present invention to eliminate the problem of proper scent intensity by providing contained scent and manual operation.

It is a further object of the present invention to completely eliminate the usage of potentially harmful solvents, gels, wicks, and waxes.

It is yet another object of the present invention to eliminate the need for electricity or electronics and mechanical service.

It is yet another object of the present invention to provide many various mounting configurations providing placement on the exterior of grates, fan guards and vents of all types as well as adhesive and plastic non-conductive prongs for placement in outlets and stand-alone applications of all types.

In keeping with the principles of the present invention, a unique scenting device is herein disclosed. The scenting device has a base unit with means of attachment to various intake airflow and HVAC grates and vents, as well as to various air outflow grates and fan systems of all types. The base unit can also be “plugged in” to electric wall outlets via non-conductive, non-functioning plastic prongs for simple mounting with no electrical function. Aforementioned base unit is also easily removable from all areas and able to be taken portably anywhere to be used in all environments, including the outdoors with potentially hundreds of scent choices. Present invention is proposed as being marketed with the title “Home Aroma Therapy,” or “Easy Fresh,” or the like.

### BRIEF DESCRIPTION OF THE DRAWINGS

FIG. 1 is an enlarged view of the face of the base unit with scent containing cartridges protruding slightly on the top. This figure also shows some proposed decorative detail.

FIG. 2 is a side view of the base unit showing the cartridges contained inside the base unit (as if base unit is transparent) with proposed various fastening methods protruding from the back.

FIG. 3 is a top view of the base unit showing the tops of the cartridges contained inside the base unit with proposed various fastening methods protruding from the back.

FIG. 4 is a rear view of the base unit showing the cartridges contained inside the base unit (as if base unit is transparent) with proposed various fastening methods protruding directly towards the viewer from the back.

FIG. 5 shows the complete unit installed in one of many proposed fashions. This particular view is on the outside of the intake grate of an HVAC or other airflow system, but mounting is not excluded to this installation. (See Abstract and claims)

### DETAILED DESCRIPTION OF DRAWINGS AND OF PREFERRED EMBODIMENTS OF THE INVENTION

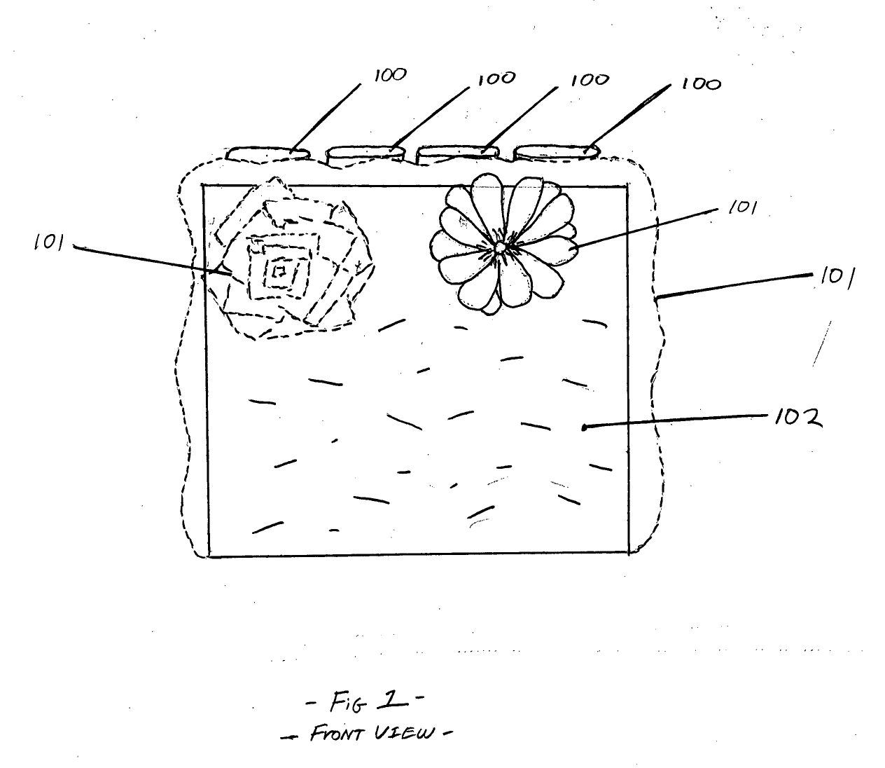

Referring to FIG. 1, therein is illustrated the face of the base unit for the proposed invention scenting device 102 that is adapted to function with existing HVAC systems, fan systems of all types, vent systems of all types mobile and stationary, ambient air and the outdoors. Scenting device base unit 102 and proposed but not necessary decorative options 101 can be composed of any rigid material. FIG. 1 also shows the removable or permanent atomizing tops 100 of the proposed scent cartridges.

Referring to FIG. 2, therein shows the side view of proposed base unit 102, removable or permanent atomizing cartridge tops 100, a portrayal of actual cartridges (there may be more or less than the FOUR depicted depending on the design) as if base unit is transparent 105, and liquid scent 103 contained in said cartridges. FIG. 2 also shows three means of the many proposed for the attaching of base unit 102. FIG. 2 104 shows a portrayal of a clip, hook, or insert to “grab” various intake grates, fan guards, and vents of all types. FIG. 2 106 shows the fixed or foldable non-conductive prongs that are insert able into electrical outlets of all types and also provide ancillary support to many proposed mounting applications. FIG. 2 107 shows an adhesive patch to aid in mounting of other methods or to supply support on its own.

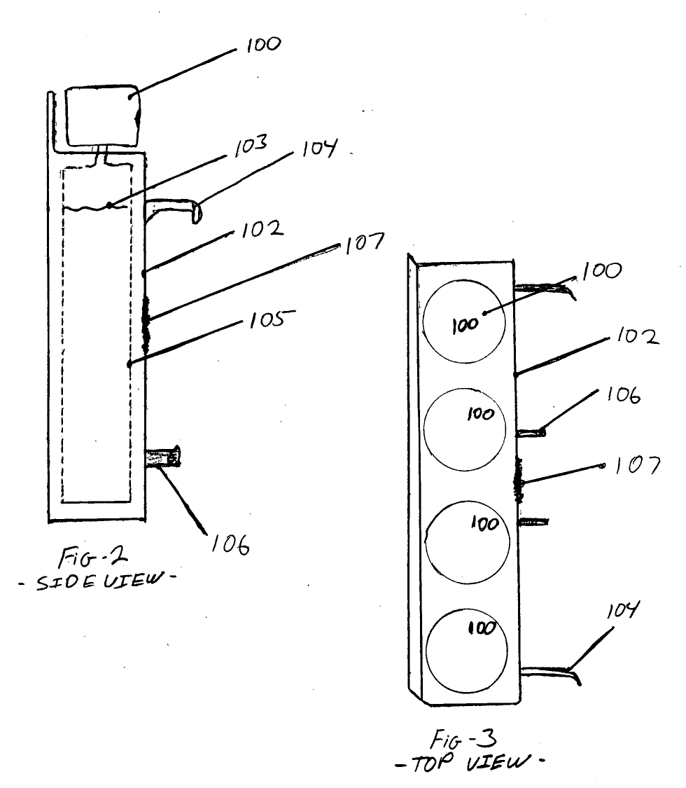

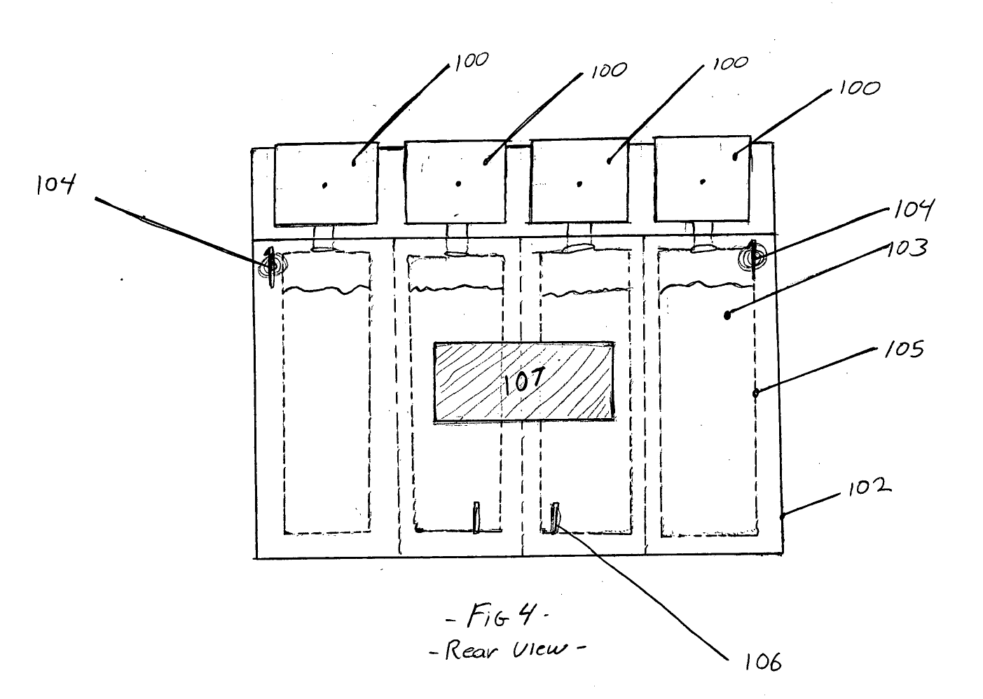

Referring to FIG. 3, therein illustrates top view of atomizing tops of scent cartridges 100. FIG. 3 104 shows the top view of a portrayal of mounting methods or a clip, hook, or insert to “grab” various intake grates, fan guards, and vents of all types. FIG. 3 106 shows a top view of the fixed or foldable non-conductive prongs that are insert able into electrical outlets of all types and also provide ancillary support to many proposed mounting applications. FIG. 3 107 shows a top view of an adhesive patch to aid in mounting of other method or to supply support on its own.

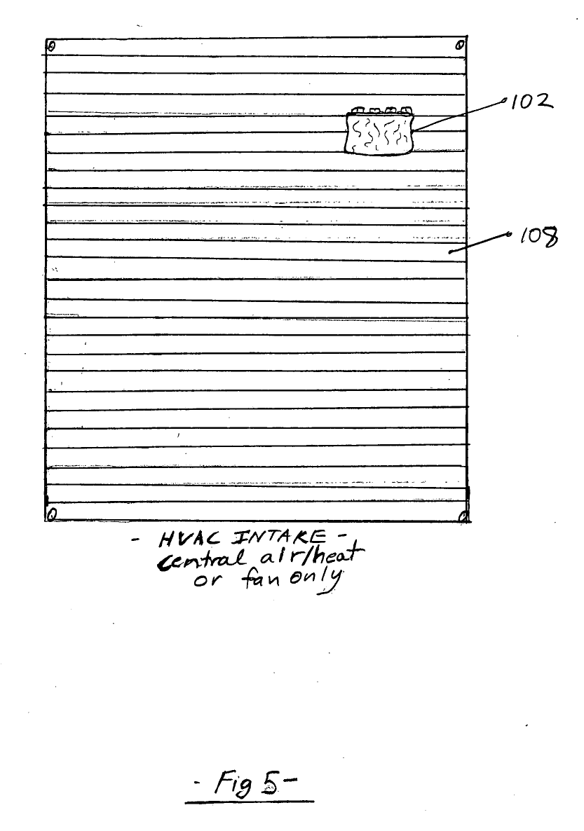

Referring to FIG. 4, therein illustrates rear view of atomizing tops of scent cartridges 100. FIG. 3 104 shows the rear view of a portrayal of mounting methods or a clip, hook, or insert to “grab” various intake grates, fan guards, and vents of all types. FIG. 3 106 shows a rear view of the fixed or foldable non-conductive prongs that are insert able into electrical outlets of all types and also provide ancillary support to many proposed mounting applications. FIG. 3 107 shows a rear view of an adhesive patch to aid in mounting of other method or to supply support on its own.

Referring to FIG. 5, therein illustrates one of the many proposed applications for the present invention showing said invention mounted on a grate or vent in a forced air application (intake or output). Figures of said present invention mounted in other proposed environments are not necessary as they are understood as outdoors, vents, fan guards, intake or output grates of all types, stand alone applications, mounted into an electrical outlet, mobile applications, and ambient indoor environments of all types.

1. A scenting device consisting of a base unit and removable cartridges for freshening air in an airflow system or ambient environment is proposed. As mentioned, the device is comprised of two basic components: component 1, A plastic base unit having slots configured to engage at least one scent cartridge per slot, thus containing one or more multiple slots and thus one or more scent cartridges per device. The base unit with multiple attaching means on said base unit for attachment to a variety of surfaces. Component 2: Scent cartridges to be inserted into the slots of aforementioned base unit for (a) individual or collective removal of cartridge(s) for dispersal into the ambient air or (b) manual dispersal of scent into the intake vent while cartridges remain in aforementioned case to freshen the entire environment served by the airflow system or (c) instant removal of entire case and multiple cartridges to be considered as portable and used in all types of automotive, recreational vehicle, hotel/motel applications or the outdoors.

2. The device of claim 1, wherein said base unit wherein said attaching means is selected from a group consisting of as, but not excluded to hook and loop fasteners, “S” hook fasteners, pins, barbs, clips, clamps, adhesives, and tapes.

3. The device of claim 1, wherein said mounting means is attached to a vent having a plurality of slotted openings such that: hook and loop fasteners, “S” hook fasteners, pins, barbs, clips, clamps, adhesives, non conductive plastic prongs and tapes can adhere to or penetrate plurality of slotted openings for attachment. This would apply to protective grates or vents of fan systems of all types.

4. The device of claim 1, wherein said case is attached into an electrical outlet with foldable or fixed non-conductive plastic or hard rubber prongs as an alternate mounting method for individual rooms and spaces, but with no electrical component or function.

5. The device of claim 1, wherein said case is not attached to any object but stands alone or to be used as a carrying case for aforementioned scent cartridges to be used at the discretion of the owner or operator of the device.

6. The device of claim 1, wherein said base unit is made of glass, metal, plastic, or cardboard.

7. The device of claim 1, wherein said cartridges are made of glass, plastic or metal.

8. The device of claim 1, wherein said cartridges contain atomizable liquids of all types.

9. The device of claim 1, wherein said cartridges can have the tops removed to allow the slow evaporation of scent into a room or ambient environment for mild consistent scenting and then closed to stop the scent dispersal immediately.

10. The device of claim 1, wherein said cartridges can have the tops removed to allow the slow evaporation of scent into an intake or outflow vent for scenting to the entire space serviced by said vent.
